(19) United States
(12) Patent Application Publication
(10) Pub. No.: US 2017/0153265 A1
(43) Pub. Date: Jun. 1, 2017

(54) WHEEL SPEED SENSOR

(71) Applicant: Sumitomo Wiring Systems, Ltd., Suzuka-city (JP)

(72) Inventors: Hironobu Yamamoto, Yokkaichi (JP); Toshinari Kobayashi, Yokkaichi (JP); Masaharu Nakamura, Yokkaichi (JP)

(21) Appl. No.: 15/359,055

(22) Filed: Nov. 22, 2016

(30) Foreign Application Priority Data
Nov. 26, 2015 (JP) 2015-230409

(51) Int. Cl. G01P 3/44

(52) U.S. Cl. CPC G01P 3/443

(57) ABSTRACT

A configuration that can generate detection signals form a plurality of system by using a plurality of sensor portions is provided, while reducing the number of components, the number of mounting man-hours, and the mounting space. A wheel speed sensor includes: a plurality of detection element portions that detect magnetic field fluctuations due to rotation of a rotor (detection target object) rotating with a wheel and convert the magnetic field fluctuations into electric signals; a plurality of output wire portions that constitute output paths respectively corresponding to the plurality of detection element portions and transmit signals dependent on outputs from the respective detection element portions; and a fixed member that constitutes a member fixed to a vehicle and integrally holds the plurality of detection element portions.

### CROSS-REFERENCE TO RELATED APPLICATIONS

This application claims priority of Japanese Patent Application No. JP2015-230409 filed Nov. 26, 2015.

### FIELD OF THE INVENTION

The present invention relates to a wheel speed sensor.

### BACKGROUND

Currently, vehicles are equipped with an anti-lock brake system for preventing the wheels from being locked during braking, a traction control system for preventing slipping during starting, and the like. As a part of such a system, a wheel speed sensor for measuring the rotational speed of a wheel is used. For example, in the wheel speed sensor disclosed in JP 2014-130100A, a Hall IC 20 that functions as a sensor portion is embedded in and covered by a resin molded portion 30, whereby a rectangular prismatic portion 11 is formed. The rectangular prismatic portion 11 is fixed to a vehicle body and opposes a rotor that rotates together with a wheel. During rotation of the wheel, the Hall IC 20 in the resin mold detects magnetic field fluctuations due to rotation of the rotor, and generates an electric signal according to the rotational speed.

JP 2014-130100A is an example of related art.

### SUMMARY OF THE INVENTION

In general, the conventional wheel speed sensor has a configuration in which only one sensor portion is disposed for one rotor at a position in proximity to the rotor, and the rotational speed of the rotor, i.e., the rotational speed of the wheel, is detected based on an electric signal from the sensor portion. However, such a configuration in which only one sensor portion is disposed opposing one rotor has the problem that a failure or the like in the sensor portion makes the detection impossible.

On the other hand, one possible method for solving this problem is a method in which two or more wheel speed sensors as disclosed in, for example, JP 2014-130100A, are disposed in proximity to one rotor, thereby providing redundant detection signals. However, this method has the problem that the number of components, the number of mounting man-hours, and the mounting space are all significantly increased as compared with these configurations in which only one wheel speed sensor is disposed in proximity to one rotor.

The present invention has been made in view of the above-described situation, and it is an object of the invention to achieve a configuration that can output detection signals reflecting a wheel speed from a plurality of systems, while suppressing the number of components, the number of mounting man-hours, and the mounting space.

A wheel speed sensor according to the present invention includes: a plurality of detection element portions configured to detect magnetic field fluctuations due to rotation of a detection target object (i.e. an object to be detected) rotating together with a wheel and convert the magnetic field fluctuations into electric signals; a plurality of output wire portions that constitute output paths respectively corresponding to the plurality of detection element portions and are configured to transmit signals dependent on outputs from the respective detection element portions; and a fixed member that constitutes a member fixed to a vehicle and integrally holds the plurality of detection element portions.

According to the present invention, a plurality of detection element portions that can detect magnetic field fluctuations due to rotation of a detection target object that rotates with a wheel, and output wire portions are provided as output paths respectively corresponding to the detection element portions. Thus, detection signals reflecting the wheel speed can be output from a plurality of systems. Furthermore, a fixed member is provided as a member fixed to a vehicle, and the fixed member is configured to integrally hold the plurality of detection element portions. With this configuration, it is possible to reduce the number of components, the number of mounting man-hours, and the mounting space as compared with a configuration in which a plurality of wheel speed sensors are separately mounted to a vehicle in order to achieve multiplexing.

### BRIEF DESCRIPTION OF THE DRAWINGS

FIG. 1 is a perspective view showing a wheel speed sensor according to Embodiment 1;

FIG. 2 is a plan view showing a part of the wheel speed sensor according to Embodiment 1;

FIG. 3 is a side view showing a part of the wheel speed sensor according to Embodiment 1;

FIG. 4 is a schematic cross-sectional view taken along the line A-A in FIG. 2;

FIG. 5 is a perspective view of a part of the wheel speed sensor according to Embodiment 1, showing a state in which a resin mold portion is omitted;

FIG. 6 is a perspective view of a part of the wheel speed sensor according to Embodiment 1, showing a state in which the resin mold portion and a fixed member are omitted;

FIG. 7 is a plan view of the state shown in FIG. 6;

FIG. 8 is an explanatory diagram showing a front view in the state shown in FIG. 6, together with a correspondence relation with a rotor;

FIG. 9 is a schematic cross-sectional view taken along the line B-B in FIG. 7;

FIG. 10(A) is a waveform chart showing output waveforms from a first detection element portion and a second detection element portion when the rotor is rotating in a forward direction, and FIG. 10(B) is a waveform chart showing output waveforms from the first detection element portion and the second detection element portion when the rotor is rotating in a reverse direction;

FIG. 11 is a perspective view showing a wheel speed sensor according to Embodiment 2;

FIG. 12 is a plan view showing a part of the wheel speed sensor according to Embodiment 2;

FIG. 13 is a side view showing a part of the wheel speed sensor according to Embodiment 2;

FIG. 14 is a schematic cross-sectional view taken along the line C-C in FIG. 12;

FIG. 15 is a perspective view of a part of the wheel speed sensor according to Embodiment 2, showing a state in which a resin mold portion is omitted;

FIG. 16 is a perspective view of a part of the wheel speed sensor according to Embodiment 2, showing a state in which the resin mold portion and a fixed member are omitted;

FIG. 17 is a plan view of a part of the wheel speed sensor according to Embodiment 2, showing a state in which the resin mold portion, the fixed member, and output wire portions are omitted;

FIG. 18 is an explanatory diagram showing a front view in the state shown in FIG. 17, together with a correspondence relation with a rotor;

FIG. 19 is a side view of the state shown in FIG. 17;

FIG. 20 is a schematic cross-sectional view taken along the line D-D in FIG. 19;

FIG. 21 is a perspective view showing a wheel speed sensor according to Embodiment 3;

FIG. 22 is a plan view showing a part of the wheel speed sensor according to Embodiment 3;

FIG. 23 is a schematic cross-sectional view taken along the line E-E in FIG. 22;

FIG. 24 is an explanatory diagram showing a front view of the wheel speed sensor according to Embodiment 3, together with a correspondence relation with a rotor;

FIG. 25 is a perspective view of a part of the wheel speed sensor according to Embodiment 3, showing a state in which a resin mold portion is omitted;

FIG. 26 is a perspective view of a part of the wheel speed sensor according to Embodiment 3, showing a state in which the resin mold portion and a fixed member are omitted;

FIG. 27 is a plan view of a second sensor head portion of the wheel speed sensor according to Embodiment 3, showing a state in which the resin mold portion is omitted;

FIG. 28 is a front view of the state shown in FIGS. 27; and

FIG. 29 is a schematic cross-sectional view taken along the line F-F in FIG. 28.

### DETAILED DESCRIPTION OF THE PREFERRED EMBODIMENTS

Hereinafter, preferred embodiments of the present invention will be described.

According to one aspect of the present invention, the plurality of detection element portions may be disposed on a virtual plane that is orthogonal to a rotation axis of the detection target object. As used herein, the rotation axis means a fixed virtual line around which the detection target object causes rotary motion, and the virtual plane means a plane, among virtual planes that are orthogonal to the rotation axis, that passes through all of the plurality of detection element portions.

With this configuration, it is possible to reduce the size of a portion in which the plurality of detection element portions and the fixed member are integrated with each other in the direction of the rotation axis of the detection target object.

According to another aspect of the present invention, at least two of the detection element portions may be disposed at different positions in a circumferential direction of the detection target object and may be configured to generate pulses at different timings.

With a configuration in which pulses are generated in at least two detection element portions at different timings in this way, the order of generation of pulses when the wheel rotates in a predetermined rotation direction is different from the order of generation of pulses when the wheel rotates in a direction opposite thereto. That is, it is possible to achieve a configuration that can determine the rotation direction of the wheel.

According to another aspect of the present invention, the plurality of detection element portions may be arranged in a direction parallel to a rotation axis of the detection target object.

With this configuration, it is possible to reduce the size of a portion in which the plurality of detection element portions and the fixed member are integrated with each other in a direction orthogonal to the rotation axis of the detection target object.

The wheel speed sensor according to the present invention may include a resin mold portion that covers all of the plurality of detection element portions.

With a configuration in which all of the plurality of detection element portions are embedded in the resin mold portion in this manner, the wheel speed sensor can be easily made more compact.

According to another aspect of the present invention, the detection element portions may include terminal portions connected to the output wire portions.

The wheel speed sensor according to the present invention may further comprise a holder portion that holds the plurality of detection element portions and defines orientations of connection surfaces of the terminal portions respectively corresponding to the detection element portions to the corresponding output wire portions.

With this configuration, the plurality of detection element portions can be held together by the holder portion, thus making the structure for holding the plurality of detection element portions and more simple and compact. Furthermore, the orientations of the connection surfaces (surfaces connecting to the output wire portions) can be stably defined at the respective terminal portions.

According to another aspect of the present invention, the holder portion may be configured to hold the plurality of detection element portions in a configuration in which a terminal portion provided for one detection element portion of the plurality of detection element portions is disposed on one side in a predetermined direction orthogonal to a rotation axis of the detection target object, and a terminal portion provided for another detection element portion of the plurality of detection element portions is disposed on the other side in the predetermined direction. Furthermore, the holder portion may be configured to hold the plurality of detection element portions in a configuration in which a connection surface of the terminal portion disposed on the one side in the predetermined direction to the corresponding one of the output wire portions faces the one side in the predetermined direction, and a connection surface of the terminal portion disposed on the other side in the predetermined direction to the corresponding one of the output wire portions faces the other side in the predetermined direction.

With this configuration, the orientation of the connection surface of the terminal portion on one side in the predetermined direction (left-right direction) can be made different from the orientation of the connection surface of the terminal portion on the other side. Accordingly, even when the plurality of detection element portions are disposed in a more compact manner and the terminal portions are densely disposed at closer positions, the terminal portions and the output wire portions are more likely to be joined in a favourable manner.

According to another aspect of the present invention, the fixed member may include an insertion hole portion through which a connecting member for connecting the fixed member to a vehicle is insertable, and, of the plurality of detection element portions, a first detection element portion may be disposed on one of opposite sides across the insertion hole portion in a circumferential direction of the detection target object, and a second detection element portion may be disposed on the other of the opposite sides across the insertion hole portion.

Further risk diversification can be achieved when the fixed member is provided with the insertion hole portion (hole portion through which a connecting member for connecting to the vehicle is inserted), and the first detection element portion and the second detection element portion are disposed on both sides thereof, as in this configuration. For example, even if impact caused by a flipped stone or the like is applied to one of the detection element portions, the impact is less likely to affect the detection element portion on the other side across the insertion hole portion. Accordingly, it is possible to further reduce the possibility that the two detection element portions fail at the same time.

### Embodiment 1

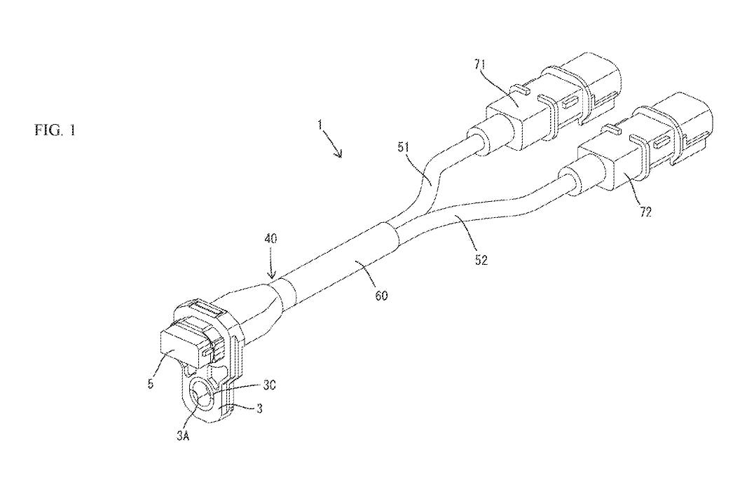

Embodiment 1 will be described below with reference to FIGS. 1 to 10.

Each of the wheel speed sensors of the present embodiment and embodiments other than the present embodiment can be used to measure the rotational speed of a wheel, for example, as a part of an anti-lock brake system for preventing the wheel from being locked during braking.

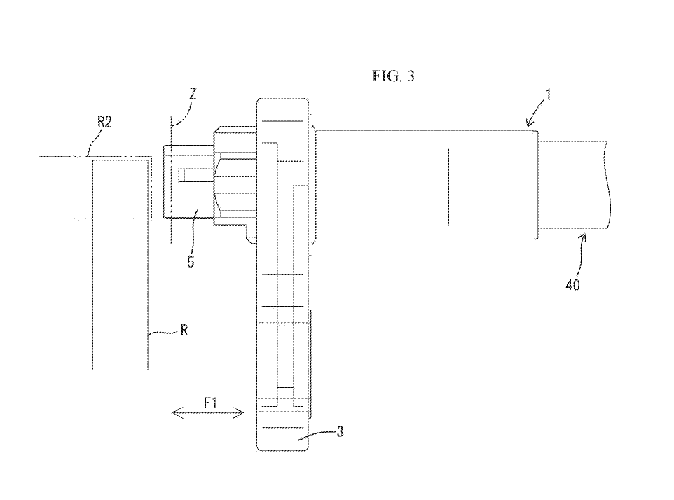

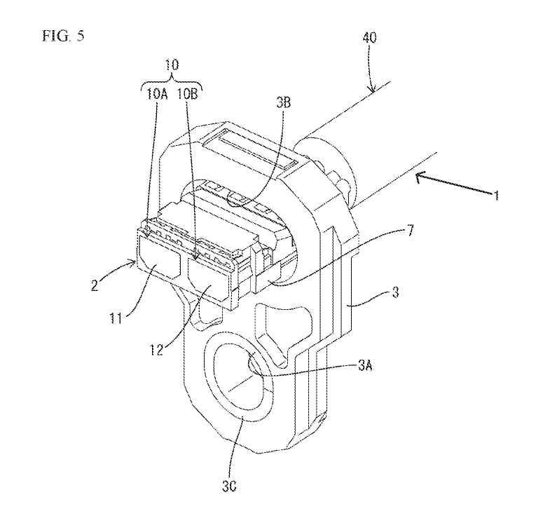

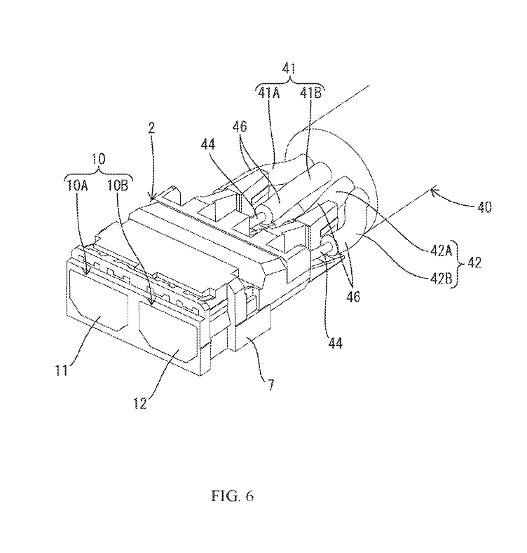

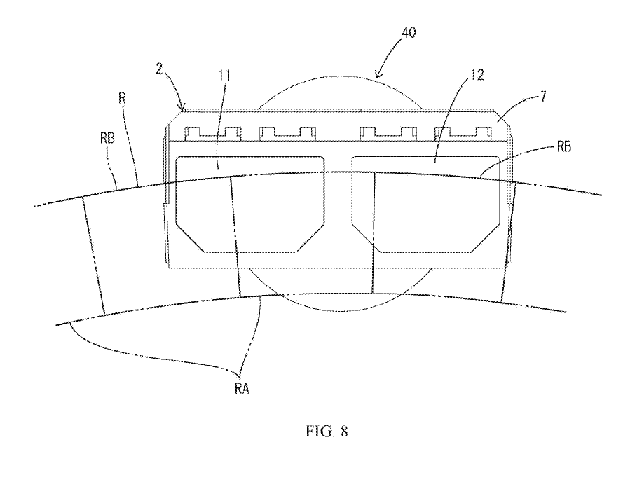

As shown in FIG. 5, a wheel speed sensor 1 includes: a plurality of detection element portions 11 and 12 that detect magnetic field fluctuations due to rotation of a rotor R (FIGS. 3 and 8) rotating with a wheel and convert the magnetic field fluctuations into electric signals; a plurality of output wire portions 41 and 42 (shown in FIG. 6) that constitute output paths respectively corresponding to the plurality of detection element portions 11 and 12 and transmit signals dependent on outputs from the respective detection element portions 11 and 12; and a fixed member 3 that constitutes a member fixed to a vehicle and integrally holds the plurality of detection element portions 11 and 12. The output wire portion 41 is specifically composed of two output wire portions 41A and 41B, and the output wire portion 42 is specifically composed of two output wire portions 42A and 42B. In the following, these components and other components will be described in detail.

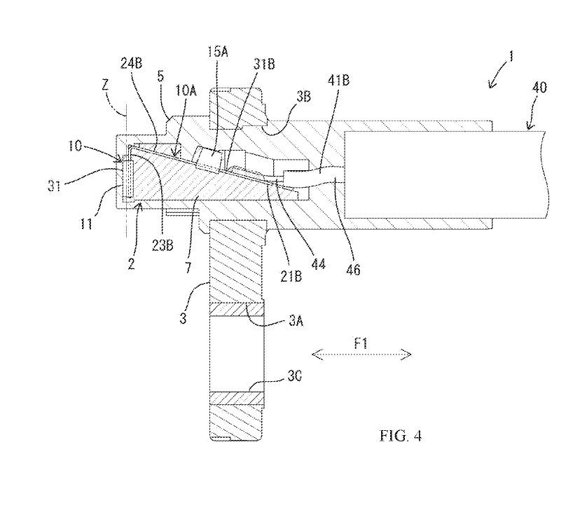

In the present configuration, the longitudinal direction of the fixed member 3 is the up-down direction, and the longitudinal direction of the resin mold portion 5 (see FIG. 4) is the front-rear direction. A direction orthogonal to the up-down direction and the front-rear direction is the left-right direction. In the following, a configuration in which the direction of the rotation axis of the rotor R is the front-rear direction, and the direction in which the plurality of detection element portions 11 and 12 are arranged is the left-right direction will be described as a representative example. As for the front-rear direction, the side on which the detection element portions 11 and 12 are disposed is the front side, and the side on which a wire harness 40 is disposed is the rear side. As for the up-down direction, the side on which the resin mold portion 5 is disposed is the upper side, and the side on which an insertion hole portion 3A is disposed is the lower side.

As shown in FIG. 3, the wheel speed sensor 1 is immobilized relative to a vehicle body (not shown) and opposes the rotor R that rotates together with a wheel (not shown) rotatably held by the vehicle body. The wheel speed sensor 1 may be disposed in any arrangement that allows each of the two detection element portions 11 and 12 to detect magnetic field fluctuations due to rotation of the rotor R. For example, the wheel speed sensor 1 may be disposed in an opposing arrangement in which the front surfaces of the two detection element portions 11 and 12 are disposed toward a planar surface (specifically, the vicinity of an outer edge portion of the planar surface) of the rotor R, as in the example of the rotor R indicated by the solid line in FIG. 3. Alternatively, the wheel speed sensor 1 may be disposed in an opposing arrangement in which the two detection element portions 11 and 12 are disposed opposite the outer circumferential surface of a rotor R2, as in the example indicated virtually by the dashed double-dotted line in FIG. 3. In the following, the example of the rotor R shown in FIGS. 3 and 8 will be described as a representative example.

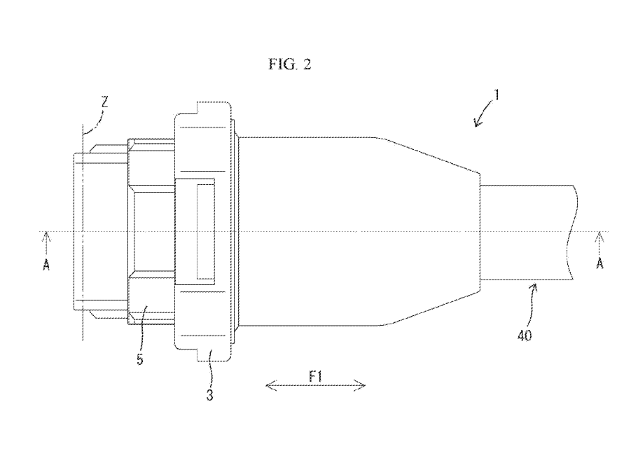

The rotor R corresponds to an example of the detection target object, and only a part of the rotor R is schematically shown in FIG. 3. The rotor R has, for example, an annular or disc-like shape, and rotates about its rotation axis in the thickness direction. For example, the outer peripheral edge of the rotor R is formed as a circular outer edge around the rotation axis, and S-pole magnetic portions RA and N-pole magnetic portions RB having the same size are alternately arranged along the outer peripheral edge. When the wheel is rotated by moving the vehicle, the rotor R rotates together with the wheel, the magnetic polarity of the portion of the rotor R that opposes the detection element portion 11 is also alternately switched between the N-pole and the S-pole, and the magnetic polarity of the portion that opposes the detection element portion 12 is also alternately switched between the N-pole and the S-pole. In FIGS. 2 to 4, the direction parallel to the direction of the rotation axis of the rotor R is indicated by the arrow F1.

The wheel speed sensor 1 has an appearance as shown in FIGS. 1 to 3, and has an internal configuration as shown in FIG. 4. As shown in FIG. 4, the wheel speed sensor 1 is mainly composed of: a detection unit 10 serving as an electric component that generates a detection signal; a holder portion 7 serving as a portion for holding the detection unit 10; a resin mold portion 5 serving as a cover for covering the detection unit 10; and a fixed member 3 configured to be fixed to a vehicle (not shown).

The detection element portions 11 and 12 are embedded on one end side of the resin mold portion 5, and the wire harness 40 extends from the other end side of the resin mold portion 5.

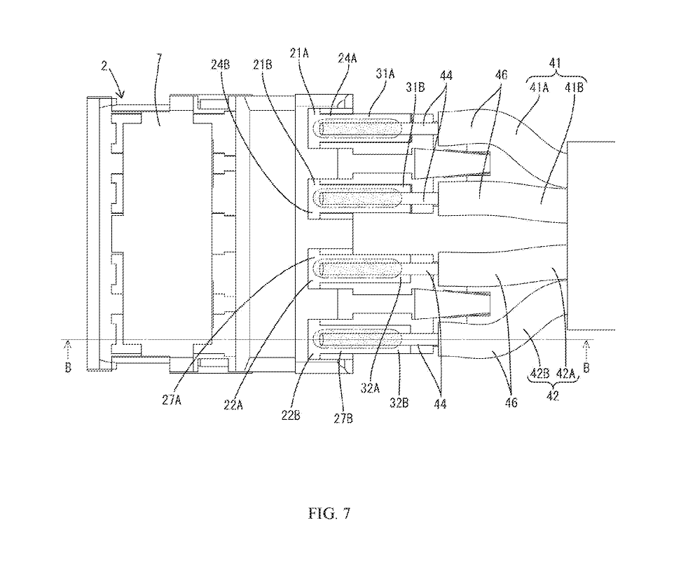

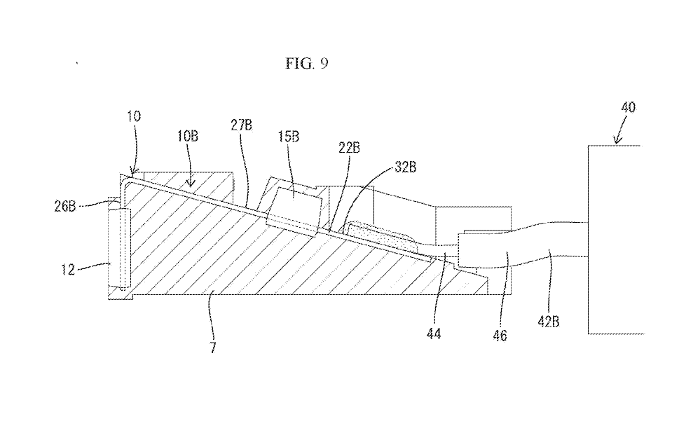

As shown in FIG. 5, the detection unit 10 includes a first detection unit 10A including the detection element portion 11 and a second detection unit 10B including the detection element portion 12. The first detection unit 10A includes a rectangular, plate-shaped detection element portion 11, two terminal portions 21A and 21B (FIG. 7) connected to the detection element portion 11, and a substantially rectangular solid-shaped capacitor 15A (FIG. 4) connected so as to span the two terminal portions 21A and 21B. The second detection unit 10B includes a rectangular, plate-shaped detection element portion 12, two terminal portions 22A and 22B (FIG. 7) connected to the detection element portion 12, and a substantially rectangular solid-shaped capacitor 15B (FIG. 9) connected so as to span the two terminal portions 22A and 22B.

Each of the detection element portions 11 and 12 shown in FIGS. 5 and 6 is configured as a Hall IC including a Hall element, and both of the detection element portions 11 and 12 constitute element portions that convert magnetic field fluctuations into electric signals and output the electric signals. Both of the detection element portions 11 and 12 are configured to be substantially plate-shaped, and are disposed such that the plate thickness direction coincides with the front-rear direction. Furthermore, the detection element portions 11 and 12 are located on a virtual plane Z that is orthogonal to the rotation axis of the rotor R, and are arranged along the circumferential direction of the rotor R.

The terminal portions 21A and 21B shown in FIG. 7 are provided corresponding to the detection element portion 11 shown in FIG. 6. The terminal portions 21A and 21B are connected, on one end side thereof, to the detection element portion 11, and are connected, on the other end side thereof, to the output wire portions 41A and 41B, respectively. As shown in FIG. 4, the terminal portion 21B is configured as a plate-shaped lead member, and a portion toward one end (toward the front end) thereof is configured as a downward extension portion 23B extending downwardly along the up-down direction. An inclined extension portion 24B is configured to be inclined relative to the front-rear direction, bending from the downward extension portion 23B. In the same manner, the terminal portion 21A is configured as a plate-shaped lead member. Although not shown, a portion toward one end (toward the front end) of the terminal portion 21A is configured as a downward extension portion extending downwardly, substantially parallel to the downward extension portion 23B. An inclined extension portion 24A (FIG. 7) that is inclined relative to the front-rear direction, bending from the downward extension portion, extends substantially parallel to the inclined extension portion 24B.

Then, the detection element portion 11 is connected to both downward extension portions of the terminal portions 21A and 21B, and the capacitor 15A (FIG. 4) is provided so as to span both inclined extension portions of the terminal portions 21A and 21B. As shown in FIG. 4, the capacitor 15A protrudes above the terminal portions 21A and 21B. As shown in FIG. 7, the upper surfaces of the terminal portions 21A and 21B in portions toward the respective rear ends of the inclined extension portions 24A and 24B are configured as connection surfaces 31A and 31B connected to the output wire portions 41A and 41B. The connection surfaces 31A and 31B are disposed obliquely upward, facing upward and rearward, and the output wire portions 41A and 41B are connected by soldering or the like to the connection surfaces 31A and 31B, respectively.

Both of the two output wire portions 41A and 41B have a structure in which a core wire 44 formed of a bundle of a plurality of wires made of a metal such as copper or aluminum serving as a conductor is covered with an electrically insulating covering member 46 made of ethylene resin, styrene resin or the like, and the core wires 44 of the output wire portions 41A and 41B are soldered to the terminal portions 21A and 21B, respectively.

The terminal portions 22A and 22B shown in FIG. 7 are provided corresponding to the detection element portion 12 shown in FIG. 6. The terminal portions 22A and 22B are connected, on one end side thereof, to the detection element portion 12, and are connected, on the other end side thereof, to the output wire portions 42A and 42B, respectively. As shown in FIG. 9, the terminal portion 22B is configured as a plate-shaped lead member, and a portion toward one end (toward the front end) thereof is configured as a downward extension portion 26B extending downwardly along the up-down direction. An inclined extension portion 27B configured to be inclined relative to the front-rear direction, bending from the downward extension portion 26B. In the same manner, the terminal portion 22A is configured in as a plate-shaped lead member. Although not shown, a portion toward one end (toward the front end) of the terminal portion 22A is configured as a downward extension portion extending downwardly, substantially parallel to the downward extension portion 26B. An inclined extension portion 27A (FIG. 7) that is inclined relative to the front-rear direction, bending from the downward extension portion, extends substantially parallel to the inclined extension portion 27B.

Then, the detection element portion 12 is connected to both downward extension portions of the terminal portions 22A and 22B, and the capacitor 15B (FIG. 9) is provided so as to span both inclined extension portions of the terminal portions 22A and 22B. The capacitor 15B protrudes above the terminal portions 22A and 22B. As shown in FIG. 7, the upper surfaces of the terminal portions 22A and 22B in portions toward the respective rear ends of the inclined extension portions 27A and 27B are configured as connection surfaces 32A and 32B connected to the output wire portions 42A and 42B. The connection surfaces 32A and 32B are disposed obliquely upward, facing upward and rearward, and the output wire portions 42A and 42B are connected by soldering or the like to the connection surfaces 32A and 32B, respectively. The two output wire portions 42A and 42B are configured in the same manner as the output wire portions 41A and 41B, and have a structure in which the core wire 44 is covered with the covering member 46, and the core wires 44 of the output wire portions 42A and 42B are soldered to the terminal portions 22A and 22B, respectively.

The holder portion 7 holds the plurality of detection element portions 11 and 12, and functions to define the orientation of the connection surfaces 31A and 31B (the surfaces connecting to the output wire portions 41A and 41B) of the terminal portions 21A and 21B corresponding to the detection element portion 11, and to define the orientation of the connection surfaces 32A and 32B (the surfaces connecting to the output wire portions 42A and 42B) of the terminal portions 22A and 22B corresponding to the detection element portion 12. Specifically, the holder portion 7 holds the detection element portions 11 and 12 in a state in which the detection element portions 11 and 12 are disposed at the front end portion, and each of the planar surfaces of the detection element portions 11 and 12 faces the front side, and holds the terminal portions 21A and 21B connected to the detection element portion 11 and the terminal portions 22A and 22B connected to the detection element portion 12 in the above-described arrangement. The holder portion 7 is formed of, for example, a synthetic resin such as polypropylene (PP) or polyamide (PA). The holder portion 7 is formed integrally with the detection unit 10, for example, by performing injection molding in a state in which the detection unit 10 is maintained in a predetermined arrangement.

As shown in FIG. 4, the resin mold portion 5 covers the detection unit 10 described above and an end portion of the wire harness 40, and is formed of, for example, a synthetic resin such as polypropylene (PP) or polyamide (PA). Specifically, a molded article 2 in which the detection unit 10 and the holder portion 7 are integrated with each other, is formed, for example, by injection molding, and after joining the output wire portions 41A, 41B, 42A, and 42B to the molded article 2, injection molding is performed on the structure (the configuration shown in FIGS. 6 and 7) obtained by joining the molded article 2 and the output wire portions 41A, 41B, 42A, and 42B.

Specifically, the resin mold portion 5 shown in FIG. 4 is formed by maintaining a part of the structure (the configuration shown in FIGS. 6 and 7) obtained by joining the molded article 2 and the output wire portions 41A, 41B, 42A, and 42B, in a state in which the aforementioned part is inserted through a through hole portion 3B of the fixed member 3 as shown in FIG. 5, and performing injection molding or the like in this state. Both of the plurality of detection element portions 11 and 12 are covered by such a resin mold portion 5, and the plurality of detection element portions 11 and 12 are embedded in the resin mold portion 5.

The wire harness 40 is configured as a single cable by bundling the four output wire portions 41A, 41B, 42A, and 42B shown in FIGS. 6 and 7 and performing resin-coating or the like on the bundle. As for the wire harness 40, the two output wire portions 41A and 41B constituting the output wire portion 41 and the two output wire portions 42A and 42B constituting the output wire portion 42 may be each bound so as to form sheathed wires, or all of the four output wire portions 41A, 41B, 42A, and 42B may be resin-coated together. In the example shown in FIG. 1 and so forth, two sheathed wires 51 and 52 respectively constituting the output wire portions 41 and 42 are bound with a rubber tube 60. The sheathed wire 51 constituting the output wire portion 41 is connected to a connector 71, and the sheathed wire 51 constituting the output wire portion 42 is connected to a connector 72. The connectors 71 and 72 are used for connection to a control device or the like installed in the vehicle.

As shown in FIGS. 1, 4 and so forth, the fixed member 3 is configured to be elongate and plate-shaped, and has an insertion hole portion 3A, which is a hole portion extending therethrough in the plate thickness direction, formed on one end side in the longitudinal direction. On the other hand, the fixed member 3 has a through hole portion 3B, which is a hole portion extending therethrough in the plate thickness direction, formed on the other side in the longitudinal direction. The insertion hole portion 3A is configured as a hole portion through which a connecting member such as a bolt is inserted, and a C-shaped retaining ring 3C made of metal is fitted onto its inner circumference. As shown in FIG. 4, the molded article 2 described above is inserted in the through hole portion 3B, and the periphery of the through hole portion 3B and the molded article 2 are fixed by the resin mold portion 5 and integrated together. The fixed member 3 configured in this manner is inserted in the insertion hole portion 3A and fixed to an appropriate place of the vehicle by means of a bolt connected to the vehicle.

In the wheel speed sensor 1 configured in this manner, both of the plurality of detection element portions 11 and 12 are disposed on a predetermined virtual plane Z that is orthogonal to the rotation axis of the rotor R (detection target object). In FIGS. 2 to 4, the position of the virtual plane Z is conceptually shown by the dashed double-dotted line.

Specifically, both of the detection element portions 11 and 12 detect switching of the magnetic field between the S-pole and the N-pole, output an H (High)-level signal with a voltage higher than or equal to a predetermined voltage when the magnetic field at the position of the detection element portion 11 is switched from the S-pole to the N-pole, and maintain the H-level signal until the magnetic field is switched from the N-pole to the S-pole. Also, both of the detection element portions 11 and 12 output an L (Low)-level signal with a voltage lower than a predetermined voltage when the magnetic field at the position of the signal detection element portion 11 is switched from the N-pole to the S-pole, and maintain the L-level signal until the magnetic field is switched from the S-pole to the N-pole. The H-level signal and the L-level signal that are output from the detection element portion 11 are output to the output wire portions 41A and 41B via the terminal portions 21A and 21B shown in FIG. 7, and a potential difference corresponding to the signals is generated in the output wire portions 41A and 41B. The H-level signal and the L-level signal that are output from the detection element portion 12 are output to the output wire portions 42A and 42B via the terminal portions 22A and 22B shown in FIG. 7, and a potential difference corresponding to the signals is generated in the output wire portions 42A and 42B.

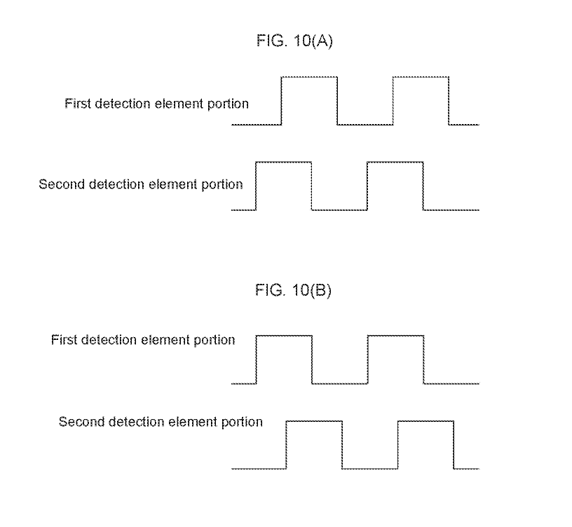

The two detection element portions 11 and 12 are disposed at different positions in the circumferential direction of the rotor R, and are configured to generate pulses at different timings. For example, in a forward rotation state in which the rotor R is rotating in a predetermined forward direction, the waveforms of the pulses output from the detection element portions 11 and 12 are as shown in FIG. 10(A). The order of output is such that after the H-level signal is output from the detection element portion 12 (second detection element portion), the H-level signal is output from the detection element portion 11 (first detection element portion). Specifically, after the rising timing of the H-level signal output from the detection element portion 12, the rising timing of the H-level signal output from the detection element portion 11 arrives. Thereafter, the falling timing of the H-level signal output from the detection element portion 12 and the falling timing of the H-level signal output from the detection element portion 11 sequentially arrive. With the wheel speed sensor 1 having the present configuration, it is possible to determine that the rotation direction of the rotor R, i.e., the rotation direction of the wheel, is the forward direction when the signals are generated in this order.

On the other hand, in a reverse rotation state in which the rotor R is rotating in a reverse direction opposite to the forward direction, the waveforms of the pulses output from the detection element portions 11 and 12 are as shown in FIG. 10(B). The order of output is such that after the H-level signal is output from the detection element portion 11 (first detection element portion), the H-level signal is output from the detection element portion 12 (second detection element portion). Specifically, after the rising timing of the H-level signal output from the detection element portion 11, the rising timing of the H-level signal output from the detection element portion 12 arrives. Thereafter, the falling timing of the H-level signal output from the detection element portion 11 and the falling timing of the H-level signal output from the detection element portion 12 sequentially arrive. With the wheel speed sensor 1 having the present configuration, it is possible to determine that the rotation direction of the rotor R, i.e., the rotation direction of the wheel, is the reverse direction when the signals are generated in this order. That is, with the present configuration, it is possible to determine whether the rotation direction of the rotor R, i.e., the rotation direction of the wheel, is forward or reverse.

As described above, the present configuration includes the plurality of detection element portions 11 and 12 that can detect magnetic field fluctuations due to rotation of the rotor R (detection target object) rotating with the wheel, and the detection element portions 11 and 12 are provided with the output wire portions 41 and 42 as output paths respectively corresponding thereto. Thus, it is possible to output detection signals reflecting a wheel speed from a plurality of systems. Furthermore, the fixed member 3 is provided as a member fixed to the vehicle, and the fixed member 3 is configured to integrally hold the plurality of detection element portions 11 and 12. With this configuration, it is possible to reduce the number of components, the number of mounting man-hours, and the mounting space as compared with a configuration in which a plurality of wheel speed sensors are separately mounted to a vehicle in order to achieve multiplexing.

In the present configuration, the plurality of detection element portions 11 and 12 are disposed on the virtual plane Z that is orthogonal to the rotation axis of the rotor R (detection target object). Thus, it is possible to reduce the size of a portion in which the plurality of detection element portions 11 and 12 and the fixed member 3 are integrated with each other in the direction of the rotation axis of the rotor R (detection target object).

In the present configuration, at least two detection element portions 11 and 12 are disposed at different positions in the circumferential direction of the rotor R (detection target object), and are configured to generate pulses at different timings. Thus, the order of generation of pulses when the wheel rotates in a predetermined rotation direction is different from the order of generation of pulses when the wheel rotates in a direction opposite thereto. That is, it is possible to achieve a configuration that can determine the rotation direction of the wheel.

In the present configuration, the resin mold portion 5 covers both of the plurality of detection element portions 11 and 12. With a configuration in which both of the plurality of detection element portions 11 and 12 are embedded in the resin mold portion 5 in this manner, the wheel speed sensor can be easily made more compact.

In the present configuration, the detection element portions 11 and 12 include the terminal portions 21A, 21B, 22A, and 22B connected to the output wire portions 41 and 42, and the holder portion 7 holds the plurality of detection element portions 11 and 12, and is configured to define the orientations of the connection surfaces 31A, 31B, 32A, and 32B to the output wire portions 41 and 42 at the terminal portions respectively corresponding to the detection element portions 11 and 12. With this configuration, the plurality of detection element portions 11 and 12 can be held together by the holder portion 7, thus making the structure for holding the plurality of detection element portions 11 and 12 more simple and compact. Furthermore, the orientations of the connection surfaces 31A, 31B, 32A, and 32B (surfaces connecting to the output wire portions) can be stably defined at the respective terminal portions 21A, 21B, 22A, and 22B.

### Embodiment 2

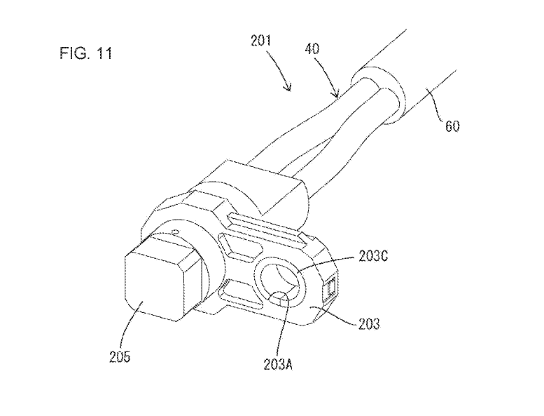

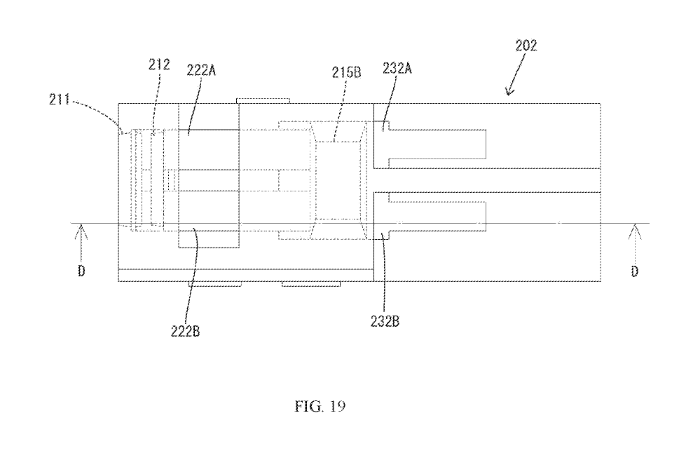

Embodiment 2 will be described with reference to FIGS. 11 to 20. Note that in the following, constituent elements that are the same as those in Embodiment 1 are denoted by the same reference numerals as those in Embodiment 1, and its detailed description has been omitted.

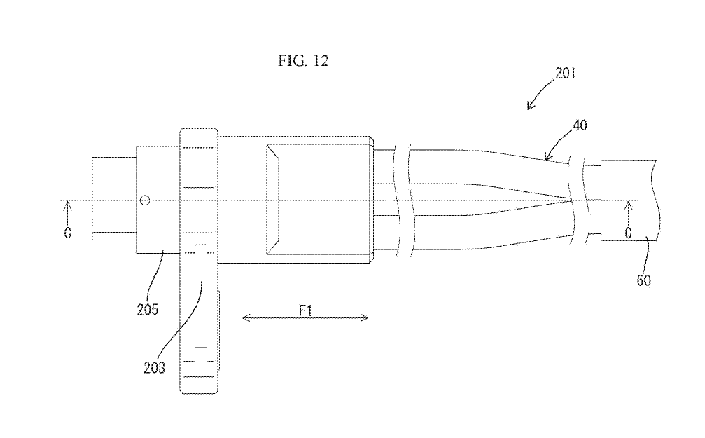

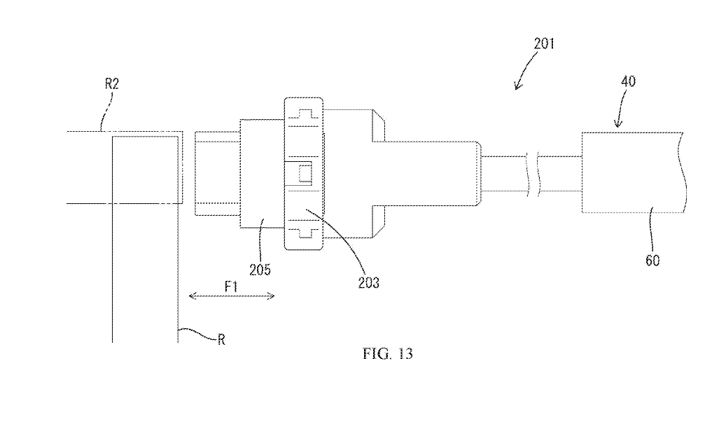

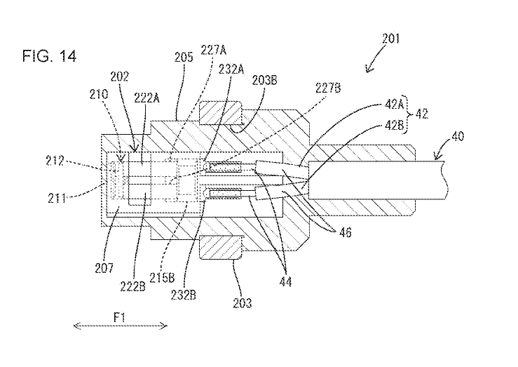

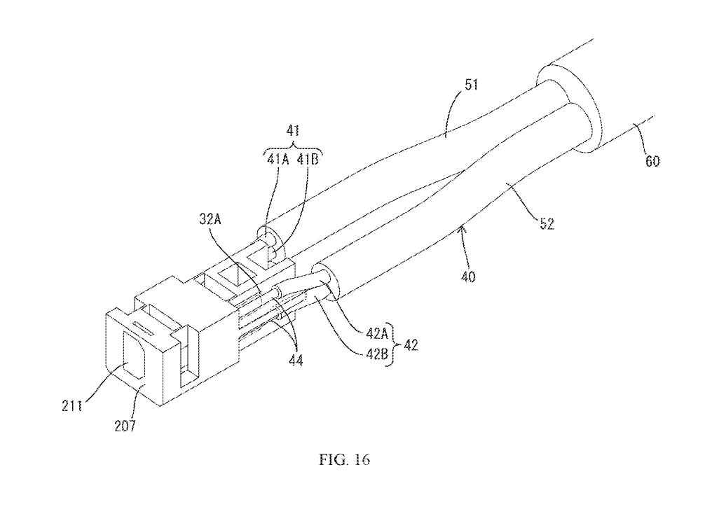

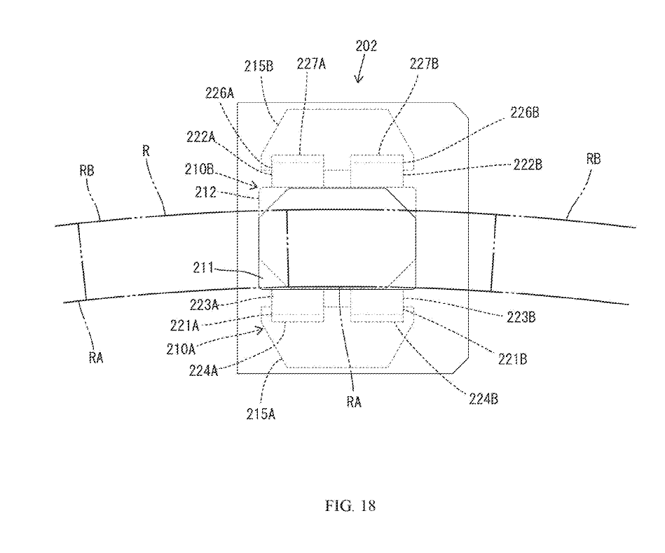

A wheel speed sensor 201 according to Embodiment 2 has an appearance as shown in FIGS. 11 to 13, and has an internal configuration as shown in FIG. 14. Note that although FIG. 14 schematically shows a cross-sectional view taken along the C-C in FIG. 12, the internal portion of a resin mold portion 205 is shown in a side view. As shown in FIG. 14, the wheel speed sensor 201 includes: a plurality of detection element portions 211 and 212 that detect magnetic field fluctuations due to rotation of a rotor R (FIGS. 13 and 18) rotating with a wheel and convert the magnetic field fluctuations into electric signals; a plurality of output wire portions 41 and 42 (FIG. 16) that constitute output paths respectively corresponding to the plurality of detection element portions 211 and 212 and transmit signals dependent on outputs from the respective detection element portions 211 and 212; and a fixed member 203 that is configured as a member fixed to a vehicle and integrally holds the plurality of detection element portions 211 and 212.

In the present configuration, the longitudinal direction of the fixed member 203 is the left-right direction, and the longitudinal direction of the resin mold portion 205 is the front-rear direction. A direction orthogonal to the left-right direction and the front-rear direction is the up-down direction. In the following, a configuration in which the rotation axis of the rotor R is the front-rear direction, and the direction in which the plurality of detection element portions 211 and 212 are arranged is the front-rear direction will be described as a representative example. As for the front-rear direction, the side on which the detection element portions 211 and 212 are disposed is the front side, and the side on which a wire harness 40 is disposed is the rear side. Note that FIG. 18 shows an example in which the wheel speed sensor 201 is mounted such that the left-right direction (the longitudinal direction of the fixed member 203) of the wheel speed sensor 201 coincides with the direction of the radius of gyration of the rotor R (the up-down direction in FIG. 18).

As shown in FIG. 13, the wheel speed sensor 201 is immobilized relative to a vehicle body and opposes the rotor R that rotates together with a wheel rotatably held by the vehicle body. For example, the wheel speed sensor 201 may be disposed in an opposing arrangement in which the direction (front-rear direction) in which the two detection element portions 211 and 212 overlap coincides with a direction parallel to the rotation axis of the rotor R, as in the example of the rotor R indicated by the solid line in FIG. 13. Alternatively, the wheel speed sensor 201 may be disposed in an opposing arrangement in which the two detection element portions 211 and 212 are disposed opposite the outer circumferential surface of a rotor R2, and the two detection element portions 211 and 212 are arranged in a radial direction that is orthogonal to the rotation axis of the rotor R2, as in the example indicated virtually by the dashed double-dotted line in FIG. 13. In the following, the example of the rotor R shown in FIGS. 13 and 18 will be described as a representative example. Note that the configuration of the rotor R itself is the same as that of Embodiment 1. In FIGS. 12 to 14, the direction parallel to the rotation axis of the rotor R is indicated by the arrow F1.

As shown in FIG. 14, the wheel speed sensor 201 is mainly composed of: a detection unit 210 serving as an electric component that generates a detection signal; a holder portion 207 serving as a portion for holding the detection unit 210; a resin mold portion 205 serving as a cover for covering the detection unit 210; and the fixed member 203 configured to be fixed to the vehicle (not shown). The detection element portions 211 and 212 are embedded on one end side of the resin mold portion 205, and the wire harness 40 extends from the other end side of the resin mold portion 205.

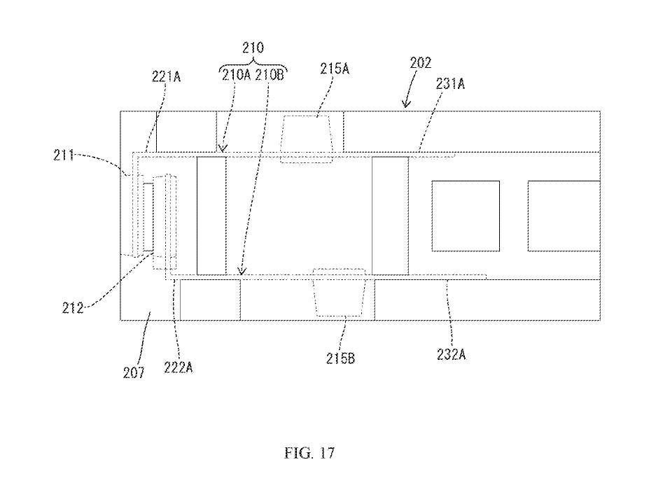

As shown in FIG. 17, the detection unit 210 includes a first detection unit 210A including the detection element portion 211 and a second detection unit 210B including the detection element portion 212.

As shown in FIG. 18, the first detection unit 210A includes a rectangular, plate-shaped detection element portion 211, two terminal portions 221A and 221B connected to the detection element portion 211, and a substantially rectangular solid-shaped capacitor 215A connected so as to span the two terminal portions 221A and 221B. The second detection unit 210B includes a rectangular, plate-shaped detection element portion 212, two terminal portions 222A and 222B connected to the detection element portion 212, and a substantially rectangular solid-shaped capacitor 215B connected so as to span the two terminal portions 222A and 222B.

The detection element portions 211 and 212 are the same Hall

ICs as the detection element portions 11 and 12 of Embodiment 1, and function in the same manner as the detection element portions 11 and 12, respectively. Both of the detection element portions 211 and 212 detect switching of the magnetic field between the S-pole and the N-pole, output an H-level signal with a voltage higher than or equal to a predetermined voltage when the magnetic field at the position at which they are disposed is switched from the S-pole to the N-pole, and output an L-level signal with a voltage below the predetermined voltage when the magnetic field at the position at which they are disposed is switched from the N-pole to the S-pole. Both of the detection element portions 211 and 212 are configured to be substantially plate-shaped, and are disposed such that the plate thickness direction coincides with the front-rear direction. The detection element portions 211 and 212 are arranged in a direction parallel to the rotation axis of the rotor R (i.e., the front-rear direction).

As shown in FIGS. 17 and 18, the terminal portions 221A and 221B are provided corresponding to the detection element portion 211. The terminal portions 221A and 221B are connected, on one end side thereof, to the detection element portion 211, and are connected, on the other end side thereof, to the output wire portions 41A and 41B, respectively (FIG. 16). The terminal portion 221A is configured as a plate-shaped lead member, and a portion toward one end (toward the front end) thereof is configured as a left-right extension portion 223A extending in the left-right direction. A front-rear extension portion 224A extends in the front-rear direction, bending from an end portion of the left-right extension portion 223A. In the same manner, the terminal portion 221B is configured as a plate-shaped lead member. A portion toward one end (toward the front end) of the terminal portion 221B is configured as a left-right extension portion 223B extending in the left-right direction, substantially parallel to the left-right extension portion 223A. A front-rear extension portion 224B extends in the front-rear direction, substantially parallel to the front-rear extension portion 224A, bending from an end portion of the left-right extension portion 223B.

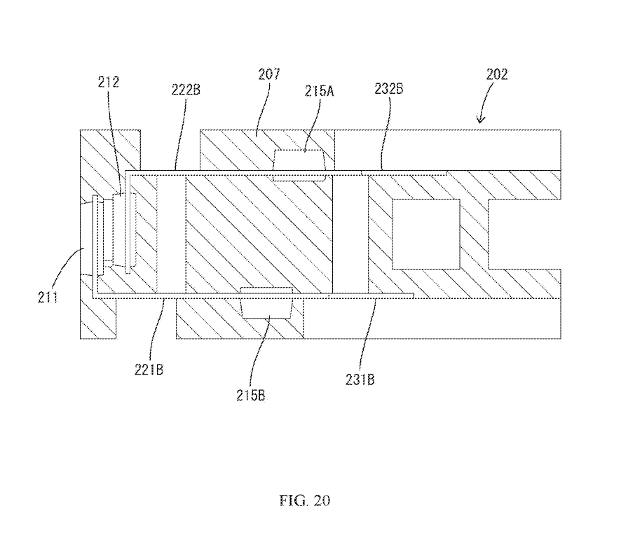

The detection element portion 211 is connected to both left-right extension portions 223A and 223B of the terminal portions 221A and 221B, and the capacitor 215A is provided so as to span both front-rear extension portions 224A and 224B. The side surfaces of the terminal portions 221A and 221B in portions toward the respective rear ends of the front-rear extension portions 224A and 224B are configured as connection surfaces 231A and 231B (see FIGS. 17 and 20) connected to the output wire portions 41A and 41B. The connection surfaces 231A and 231B are disposed laterally, facing to one side of the left-right direction (the side opposite to the connection surfaces 232A and 232B of the terminal portions 222A and 222B), and the core wires 44 of the output wire portions 41A and 41B are soldered to the connection surfaces 231A and 231B, respectively.

As shown in FIGS. 17 and 18, the terminal portions 222A and 222B are provided corresponding to the detection element portion 212. The terminal portions 222A and 222B are connected, on one end side thereof, to the detection element portion 212, and are connected, on the other end side thereof, to the output wire portions 42A and 42B, respectively (FIG. 16). The terminal portion 222A is configured as a plate-shaped lead member, and a portion toward one end (toward the front end) thereof is configured as a left-right extension portion 226A extending in the left-right direction. A front-rear extension portion 227A extends in the front-rear direction, bending from an end portion of the left-right extension portion 226A. In the same manner, the terminal portion 222B is configured as a plate-shaped lead member. A portion toward one end (toward the front end) of the terminal portion 222B is configured as a left-right extension portion 226B extending in the left-right direction, substantially parallel to the left-right extension portion 226A. A front-rear extension portion 227B extends in the front-rear direction, substantially parallel to the front-rear extension portion 227A, bending from an end portion of the left-right extension portion 226B.

The detection element portion 212 is connected to both left-right extension portions 226A and 226B of the terminal portions 222A and 222B, and the capacitor 215B is provided so as to span both front-rear extension portions 227A and 227B. The side surfaces of the terminal portions 222A and 222B in portions toward the respective rear ends of the front-rear extension portions 227A and 227B are configured as connection surfaces 232A and 232B (see FIGS. 17 and 20) connected to the output wire portions 41A and 41B. The connection surfaces 232A and 232B are disposed laterally, facing to the other side in the left-right direction (the side opposite to the connection surfaces 231A and 231B), and the core wires 44 of the output wire portions 42A and 42B are soldered to the connection surfaces 232A and 232B, respectively.

The holder portion 207 shown in FIGS. 17 to 20 holds the plurality of detection element portions 211 and 212, and functions to define the orientation of the connection surfaces 231A and 231B (the surfaces connecting to the output wire portions 41A and 41B) of the terminal portions 221A and 221B corresponding to the detection element portion 211, and to define the orientation of the connection surfaces 232A and 232B (the surfaces connecting to the output wire portions 42A and 42B) of the terminal portions 222A and 222B corresponding to the detection element portion 212. The holder portion 207 holds the detection element portions 211 and 212 in a state in which the detection element portions 211 and 212 are disposed at the front end portion, and each of the planar surfaces of the detection element portions 211 and 212 faces the front side, and holds the terminal portions 221A and 221B connected to the detection element portion 211 and the terminal portions 222A and 222B connected to the detection element portion 212 in the above-described arrangement. The holder portion 207 is formed of, for example, a synthetic resin such as polypropylene (PP) or polyamide (PA). The holder portion 207 is formed integrally with the detection unit 210, for example, by performing injection molding in a state in which the detection unit 210 is maintained in a predetermined arrangement.

More specifically, the holder portion 207 holds the detection element portions 211 and 212 in a state in which the terminal portions 221A and 221B provided in the detection element portion 211 (one detection element portion) are disposed on one side in a predetermined direction (specifically, the left-right direction) orthogonal to the rotation axis of the rotor R, and the terminal portions 222A and 222B provided in the detection element portion 212 (another detection element portion) are disposed on the other side in the predetermined direction (left-right direction). Furthermore, the holder portion 207 holds the first detection unit 210A and the second detection unit 210B in a configuration in which the connection surfaces 231A and 231B (the surfaces connecting to the output wire portions 41A and 41B) of the terminal portions 221A and 221B disposed on one side in the left-right direction face one side in the left-right direction, and the connection surfaces 232A and 232B (the surfaces connecting to the output wire portions 42A and 42B) of the terminal portions 222A and 222B disposed in the other side in the left-right direction face the other side in the left-right direction.

As shown in FIG. 14, the resin mold portion 205 covers the detection unit 210 described above and an end portion of the wire harness 40, and is formed of, for example, a synthetic resin such as polypropylene (PP) or polyamide (PA). Specifically, as shown in FIGS. 17 to 20, a molded article 202 in which the detection unit 210 and the holder portion 207 are integrated with each other is formed, for example, by injection molding, and after joining the output wire portions 41A, 41B, 42A, and 42B to the molded article 202, injection molding is performed on the structure (the configuration shown in FIG. 16) obtained by joining the molded article 202 and the output wire portions 41A, 41B, 42A, and 42B.

Specifically, the resin mold portion 205 shown in FIG. 14 is formed by maintaining a part of the structure (the configuration shown in

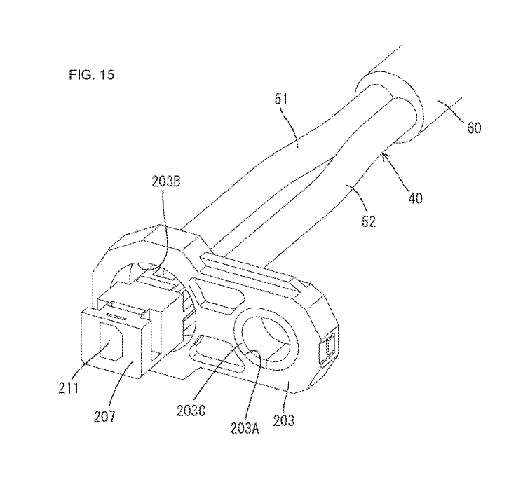

FIG. 16) obtained by joining the molded article 202 and the output wire portions 41A, 41B, 42A, and 42B, in a state in which the aforementioned part is inserted through a through hole portion 203B of the fixed member 203 as shown in FIG. 15, and performing injection molding or the like in this state. Both of the plurality of detection element portions 211 and 212 are covered by such a resin mold portion 205, and the plurality of detection element portions 211 and 212 are embedded in the resin mold portion 205.

The wire harness 40 is configured in the same manner as in Embodiment 1. For example, as shown in FIG. 16, the two output wire portions 41A and 41B constituting the output wire portion 41 and the two output wire portions 42A and 42B constituting the output wire portion 42 may be each bound so as to form sheathed wires 51 and 52. The present invention is not limited to this example, and the four output wire portions 41A, 41B, 42A, and 42B may be resin-coated together. In this configuration as well, the two sheathed wires 51 and 52 respectively constituting the output wire portions 41 and 42 are bound with a rubber tube 60.

As shown in FIGS. 11, 14 and so forth, the fixed member 203 is configured to be elongate and plate-shaped, and has an insertion hole portion 203A, which is a hole portion extending therethrough in the plate thickness direction, formed on one end side in the longitudinal direction, and a C-shaped retaining ring 203C made of metal is fitted onto its inner circumference. On the other hand, the fixed member 203 has a through hole portion 203B, which is a hole portion extending therethrough in the plate thickness direction, formed on the other side in the longitudinal direction. As shown in FIG. 14, the molded article 202 described above is inserted in the through hole portion 203B, and the periphery of the through hole portion 203B and the molded article 202 are fixed by the resin mold portion 205 and integrated together. The fixed member 203 configured in this manner is inserted in the insertion hole portion 203A and fixed to an appropriate place of the vehicle by means of a bolt connected to the vehicle.

The present configuration as described above can achieve the same effect as that of Embodiment 1.

In the present configuration, the plurality of detection element portions 211 and 212 are arranged in a direction parallel to the rotation axis of the rotor R (detection target object). Accordingly, it is possible to reduce the size of a portion in which the plurality of detection element portions 211 and 212 and the fixed member 203 are integrated with each other in a direction orthogonal to the rotation axis of the rotor R (detection target object).

Furthermore, with the present configuration, the orientation of the connection surfaces of the terminal portions 221A and 221B on one side in the predetermined direction (left-right direction) can be made different from the orientation of the connection surfaces of the terminal portions 222A and 222B on the other side. Accordingly, even when the plurality of detection element portions 211 and 212 are disposed in a more compact manner and the terminal portions 221A, 221B, 222A, and 222B are densely disposed at closer positions, the terminal portions 221A, 221B, 222A, and 222B and the output wire portions 41A, 41B, 42A, and 42B are more likely to be joined in a favourable manner.

### Embodiment 3

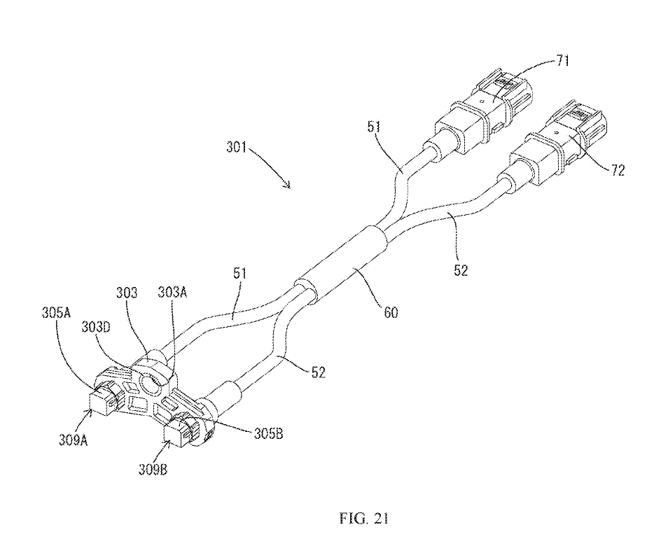

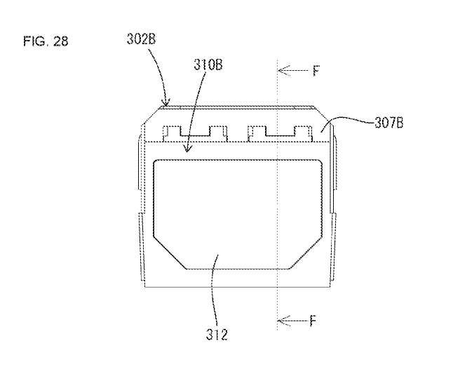

Embodiment 3 will be described with reference to FIGS. 21 to 29. Note that in the following, constituent elements that are the same as those in Embodiment 1 are denoted by the same reference numerals as those in Embodiment 1, and its detailed description has been omitted.

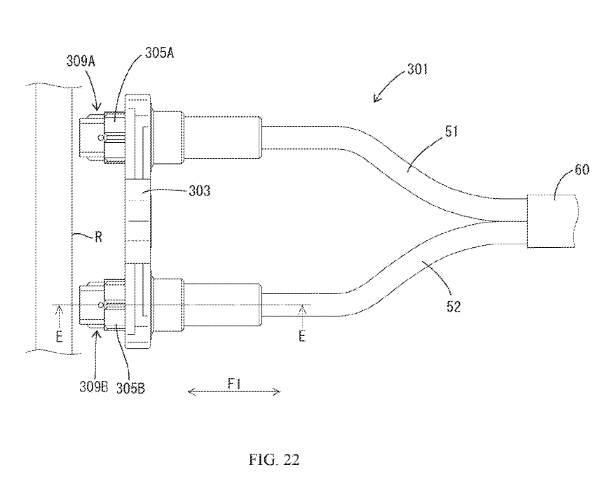

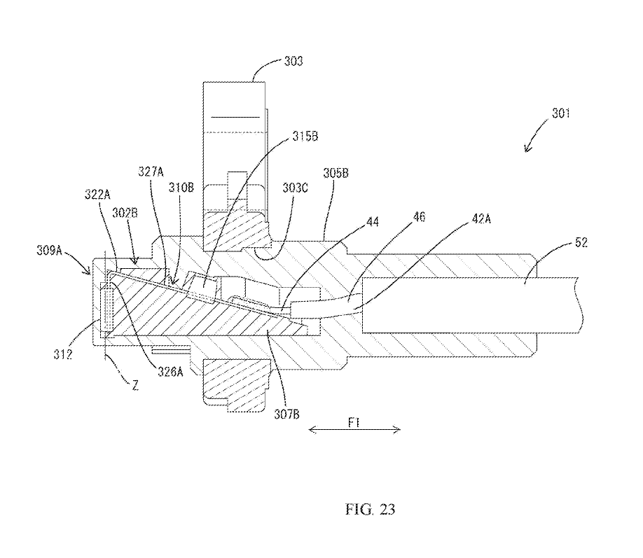

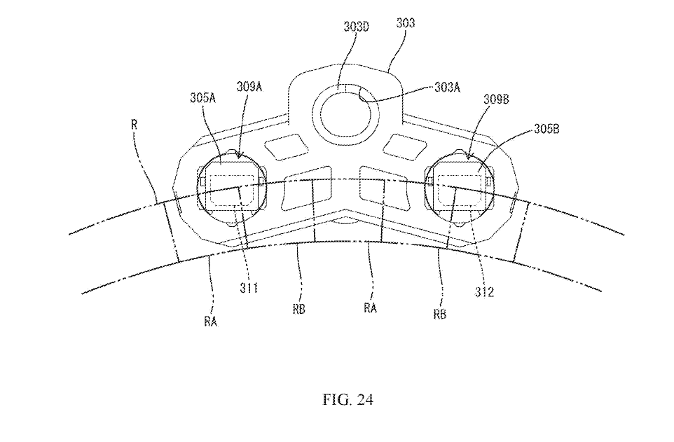

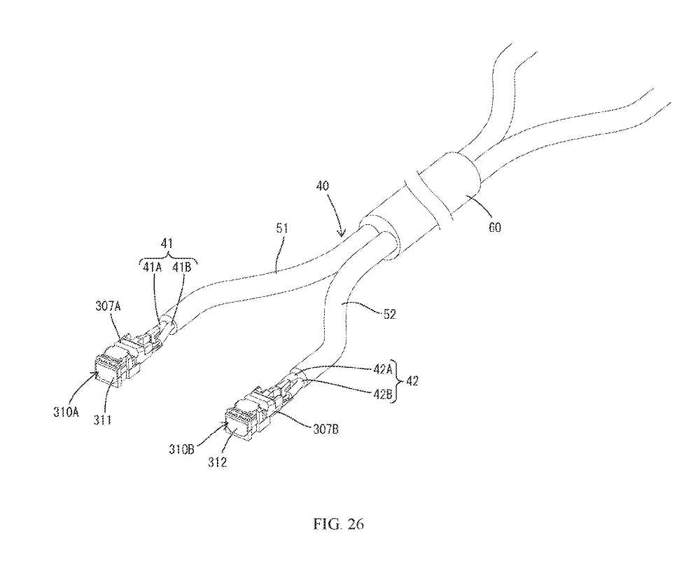

A wheel speed sensor 301 according to Embodiment 3 has an appearance as shown in FIGS. 21 and 22, and has an internal configuration as shown in FIG. 23. The wheel speed sensor 301 includes: a plurality of detection element portions 311 and 312 that detect magnetic field fluctuations due to rotation of a rotor R (FIGS. 22 and 24) rotating with a wheel and convert the magnetic field fluctuations into electric signals; a plurality of output wire portions 41 and 42 (FIG. 26) that constitute output paths respectively corresponding to the plurality of detection element portions 311 and 312 and transmit signals dependent on outputs from the respective detection element portions 311 and 312; and a fixed member 303 that is configured as a member fixed to a vehicle and integrally holds the plurality of detection element portions 311 and 312.

The detection element portions 311 and 312 are the same Hall

ICs as the detection element portions 11 and 12 of Embodiment 1, and function in the same manner as the detection element portions 11 and 12, respectively. Both of the detection element portions 311 and 312 detect switching of the magnetic field between the S-pole and the N-pole, output an H-level signal with a voltage higher than or equal to a predetermined voltage when the magnetic field at the position at which they are disposed is switched from the S-pole to the N-pole, and output an L-level signal with a voltage below the predetermined voltage when the magnetic field at the position at which they are disposed is switched from the N-pole to the S-pole. Both of the detection element portions 311 and 312 are configured to be substantially plate-shaped, and are disposed such that the plate thickness direction coincides with the front-rear direction. Both of the detection element portions 311 and 312 are disposed on a predetermined virtual plane Z that is orthogonal to the rotation axis of the rotor R, and are arranged along the circumferential direction of the rotor R.

In the present configuration as well, a wire harness 40 is configured in the same manner as in Embodiment 1. For example, as shown in FIG. 26, the two output wire portions 41A and 41B constituting the output wire portion 41 and the two output wire portions 42A and 42B constituting the output wire portion 42 may be each bound so as to form sheathed wires 51 and 52. In this configuration as well, the two sheathed wires 51 and 52 respectively constituting the output wire portions 41 and 42 are bound with a rubber tube 60.

In the present configuration, the longitudinal direction of resin mold portions 305A and 305B is the front-rear direction, the direction in which the plurality of detection element portions 311 and 312 are arranged is the left-right direction, and a direction orthogonal to to the front-rear direction and the left-right direction is the up-down direction.

In the following, a configuration in which the rotation axis of the rotor R is the front-rear direction will be described as a representative example. As for the front-rear direction, the side on which the detection element portions 311 and 312 are disposed is the front side, and the side on which the wire harness 40 is disposed is the rear side. As for the up-down direction, the side on which the resin mold portions 305A and 305B are disposed is the lower side, and the side on which the insertion hole portion 303A is disposed is the upper side.

As shown in FIG. 22, the wheel speed sensor 301 is immobilized relative to a vehicle body and opposes the rotor R that rotates together with a wheel rotatably held by the vehicle body. In the example shown in FIGS. 22 and 24, the wheel speed sensor 301 is disposed in an opposing arrangement in which the front surfaces of the two detection element portions 311 and 312 are disposed toward the planar surface (specifically, the vicinity of the outer edge portion of the planar surface) of the rotor R. In FIGS. 22 and 23, the direction parallel to the direction of the rotation axis of the rotor R is indicated by the arrow F1.

The wheel speed sensor 301 shown in FIG. 21 is mainly composed of: two detection units 310A and 310B (FIG. 26) serving as electric components that generate detection signals; holder portions 307A and 307B (FIG. 26) serving as portions for holding the detection units 310A and 310B, respectively; resin mold portions 305A and 305B serving as covers for covering the detection units 310A and 310B, respectively; and a fixed member 303 configured to be fixed to the vehicle (not shown). The detection element portion 311 shown in FIG. 26 is embedded on one end side of the resin mold portion 305A, and the sheathed wire 51 constituting the output wire portion 41 extends from the other end side of the resin mold portion 305A. The detection element portion 312 shown in FIG. 26 is embedded on one end side of the resin mold portion 305B, and the sheathed wire 52 constituting the output wire portion 42 extends from the other end side of the resin mold portion 305B.

In the present configuration, a first sensor head portion 309A, which is a portion in which the detection unit 310A is covered by the resin mold portion 305A, and a second sensor head portion 309B, which is a portion in which the detection unit 310B is covered by the resin mold portion 305B, have the same structure. Accordingly, the following description is focused on the second sensor head portion 309B, and the detailed description has been omitted for the first sensor head portion 309A, which has the same structure as the second sensor head portion 309B.

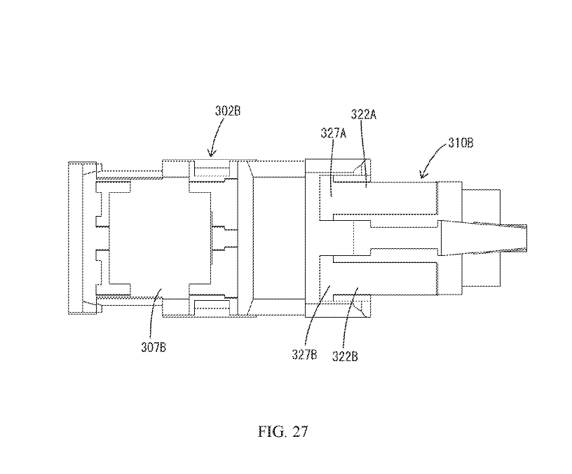

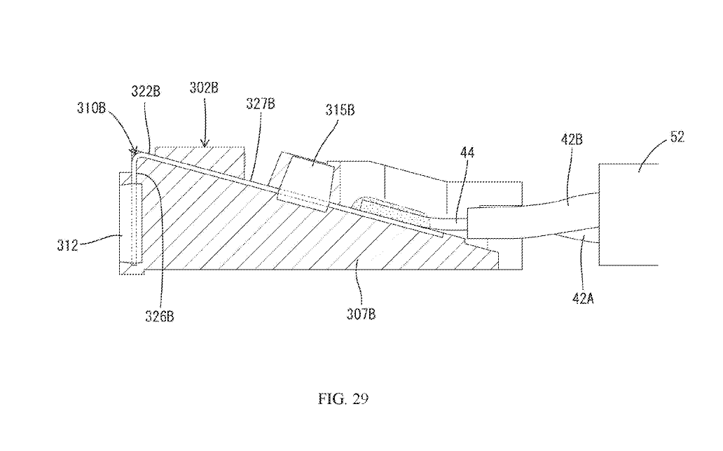

As shown in FIG. 23, the second detection unit 310B constituting a part of the second sensor head portion 309B includes a rectangular, plate-shaped detection element portion 312, two terminal portions 322A and 322B (FIG. 27) connected to the detection element portion 312, and a substantially rectangular solid-shaped capacitor 315B connected so as to span the two two terminal portions 322A and 322B. The terminal portions 322A and 322B are provided corresponding to the detection element portion 312. The terminal portions 322A and 322B are connected, on one end side thereof, to the detection element portion 312, and are connected, on the other end side thereof, to the output wire portions 42A and 42B, respectively (FIG. 26). The terminal portion 322A is configured as a plate-shaped lead member, and a portion toward one end (toward the front end) thereof is configured as a downward extension portion 326A extending downwardly along the up-down direction. An inclined extension portion 327A is configured to be inclined relative to the front-rear direction, bending from the downward extension portion 326A. In the same manner, the terminal portion 322B is configured as a plate-shaped lead member. Although not shown, a portion toward one end (toward the front end) of the terminal portion 322B is configured as a downward extension portion 326B (FIG. 29) extending downwardly, substantially parallel to the downward extension portion 326A. An inclined extension portion 327B (FIGS. 27 and 29) that is inclined relative to the front-rear direction, bending from the downward extension portion extends substantially parallel to the inclined extension portion 327A.

Then, the detection element portion 312 is connected to both downward extension portions of the terminal portions 322A and 322B, and the capacitor 315B is provided so as to span both inclined extension portions of the terminal portions 322A and 322B. The upper surfaces of the terminal portions 322A and 322B in portions toward the respective rear ends of the inclined extension portions are configured as connection surfaces connected to the output wire portions 42A and 42B. The output wire portions 42A and 42B are connected by soldering or the like to the connection surfaces of the terminal portions 322A and 322B, respectively.

The holder portion 307B shown in FIGS. 27 to 29 holds the detection element portion 312 in a state in which the detection element portion 312 is disposed at the front end portion, and the planar surface of the detection element portion 312 faces the front side, and holds the terminal portions 322A and 322B connected to the detection element portion 312 such that the connection surface is disposed obliquely upward.

The holder portion 307B is formed of, for example, a synthetic resin such as polypropylene (PP) or polyamide (PA), and is formed integrally with the detection unit 310B (FIG. 29), for example, by performing injection molding in a state in which the detection unit 310B is maintained in a predetermined arrangement.

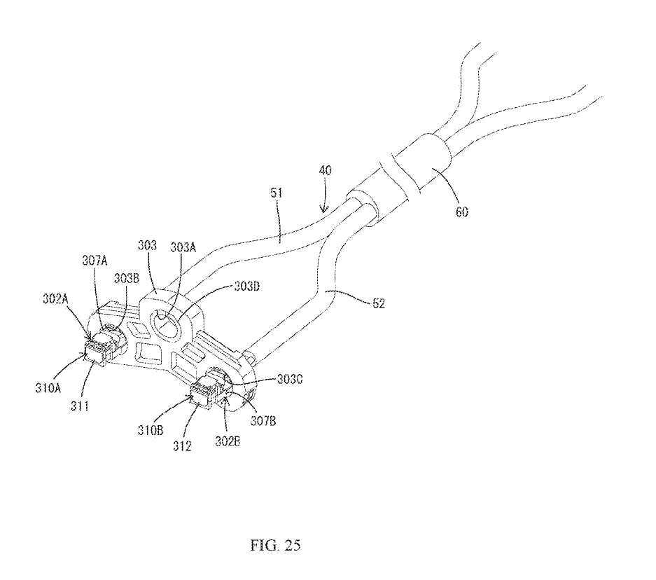

As shown in FIG. 23, the resin mold portion 305B covers the detection unit 310B described above and an end portion of the sheathed wire 52, and is formed of, for example, a synthetic resin such as polypropylene (PP) or polyamide (PA). Specifically, first, a molded article 302B (FIGS. 27 to 29) in which the detection unit 310B and the holder portion 307B are integrated with each other is formed, for example, by injection molding, and after joining the output wire portions 42A and 42B to the molded article 302B, injection molding is performed on the structure (the configuration shown in FIG. 26) obtained by joining the molded article 302 and the output wire portions 42A and 42B. Specifically, the resin mold portion 305B shown in FIG. 23 is formed by maintaining a part of the structure (the configuration shown in FIG. 26) obtained by joining the molded article 302B and the output wire portions 42A and 42B, in a state in which the aforementioned part is inserted through a through hole portion 303C of the fixed member 303 as shown in FIG. 25, and performing injection molding or the like in this state.

As shown in FIGS. 21 and 24, the fixed member 303 includes the insertion hole portion 303A through which a connecting member (e.g., a bolt) for connecting the fixed member 303 to the vehicle is inserted. The detection element portion 311 (first detection element portion) is disposed on one of opposite sides across the insertion hole portion 303A in the circumferential direction of the rotor R, and the detection element portion 312 (second detection element portion) is disposed on the other of the opposite sides across the insertion hole portion 303A. The fixed member 303 is configured to be elongate and plate-shaped. In the present configuration, the circumferential direction of the rotor R coincides with the longitudinal direction of the fixed member 303. Also, the fixed member 303 has an insertion hole portion 303A, which is a hole portion extending therethrough in the plate thickness direction, formed in the vicinity of the central portion in the longitudinal direction, and a C-shaped retaining ring 303D made of metal is fitted onto its inner circumference. The fixed member 303 has a through hole portion 303B, which is a hole portion extending therethrough in the plate thickness direction, formed on one side in the longitudinal direction around the insertion hole portion 303A (one side in the circumferential direction), and has a through hole portion 303C, which is a hole portion extending therethrough in the plate thickness direction, formed on the other side in the longitudinal direction. The molded article 302B described above is inserted in the through hole portion 303C, and the periphery of the through hole portion 303C and the molded article 302B are fixed by the resin mold portion 305B and integrated with each other.

The second sensor head portion 309B formed by covering the molded article 302B by the resin mold portion 305B is fixed to the fixed member 303 by the above-described configuration. The first sensor head portion 309A has the same configuration as that of the second sensor head portion 309B, and is fixed to the fixed member 303 by the same method so as to be inserted through the through hole portion 303B. The fixed member 303 is inserted in the insertion hole portion 303A, and fixed to an appropriate place of the vehicle by means of a bolt connected to the vehicle.

In the present configuration as well, pulses are generated as shown in FIGS. 10(A) and 10(B). That is, the two detection element portions 311 and 312 are disposed at different positions in the circumferential direction of the rotor R, and are configured to generate pulses at different timings. In a forward rotation state in which the rotor R is rotating in a predetermined forward direction, the waveforms of the pulses output from the detection element portions 311 and 312 are as shown in FIG. 10(A). It is possible to determine that the rotation direction of the rotor R, i.e., the rotation direction of the wheel, is the forward direction when the signals are generated in this order. On the other hand, in a reverse rotation state in which the rotor R is rotating in a reverse direction opposite to the forward direction, the waveforms of the pulses output from the detection element portions 311 and 312 are as shown in FIG. 10(B). It is possible to determine that the rotation direction of the rotor R, i.e., the rotation direction of the wheel, is the reverse direction when the signals are generated in this order. Thus, with the present configuration as well, it is possible to determine whether the rotation direction of the rotor R, i.e., the rotation direction of the wheel, is forward or reverse.

The present configuration as described above can achieve the same effect as that of Embodiment 1.

Further risk diversification can be achieved when the fixed member 303 is provided with the insertion hole portion 303A (hole portion through which a connecting member for connecting to the vehicle is inserted), and the detection element portion 311 (first detection element portion) and the detection element portion 312 (second detection element portion) are disposed on both sides thereof, as in the present configuration. For example, even if impact caused by a flipped stone or the like is applied to one of the detection element portions, the impact is less likely to affect the detection element portion on the other side across the insertion hole portion 303A. Accordingly, it is possible to further reduce the possibility that the two detection element portions 311 and 312 fail at the same time.

### Other Embodiments

In the following, other embodiments will be briefly described. (1) Although the above-described embodiments show an example in which the detection element portion is configured as a Hall IC including a Hall element, the detection element portion may be composed of a magnetoresistance element. (2) Although the above-described embodiments show an example in which two detection element portions are integrated with the fixed member, three or more detection element portions may be integrated with the fixed member in any of the embodiments.

What is claimed is:

1. A wheel speed sensor comprising:
a plurality of detection element portions configured to detect magnetic field fluctuations due to rotation of a detection target object rotating together with a wheel and to convert the magnetic field fluctuations into electric signals;
a plurality of output wire portions that constitute output paths respectively corresponding to the plurality of detection element portions and transmit signals dependent on outputs from the respective detection element portions; and
a fixed member that constitutes a member fixed to a vehicle and integrally holds the plurality of detection element portions.

2. The wheel speed sensor according to claim 1,
wherein the plurality of detection element portions are disposed on a virtual plane that is orthogonal to a rotation axis of the detection target object.

3. The wheel speed sensor according to claim 1,
wherein at least two of the detection element portions are disposed at different positions in a circumferential direction of the detection target object and are configured to generate pulses at different timings.

4. The wheel speed sensor according to claim 1,
wherein the plurality of detection element portions are arranged in a direction parallel to a rotation axis of the detection target object.

5. The wheel speed sensor according to claim 1,
comprising a resin mold portion that covers all of the plurality of detection element portions.

6. The wheel speed sensor according to claim 5,
wherein terminal portions that are connected to the output wire portions are provided respectively corresponding to the detection element portions; and
the wheel speed sensor further comprises a holder portion that holds the plurality of detection element portions and defines orientations of connection surfaces of the terminal portions respectively corresponding to the detection element portions to the corresponding output wire portions.

7. The wheel speed sensor according to claim 6,
wherein the holder portion holds the plurality of detection element portions in a configuration in which a terminal portion provided corresponding to one detection element portion of the plurality of detection element portions is disposed on one side in a predetermined direction orthogonal to a rotation axis of the detection target object, a terminal portion provided corresponding to another detection element portion of the plurality of detection element portions is disposed on the other side in the predetermined direction, a connection surface of the terminal portion disposed on the one side in the predetermined direction to the corresponding one of the output wire portions faces the one side in the predetermined direction, and a connection surface of the terminal portion disposed on the other side in the predetermined direction to the corresponding of the output wire portions faces the other side in the predetermined direction.

8. The wheel speed sensor according to claim 1,
wherein the fixed member includes an insertion hole portion through which a connecting member for connecting the fixed member to a vehicle is insertable, and,
of the plurality of detection element portions, a first detection element portion is disposed on one of opposite sides across the insertion hole portion in a circumferential direction of the detection target object, and a second detection element portion is disposed on the other of the opposite sides across the insertion hole portion.

9. The wheel speed sensor according to claim 2,
wherein at least two of the detection element portions are disposed at different positions in a circumferential direction of the detection target object and are configured to generate pulses at different timings.

10. The wheel speed sensor according to claim 2, comprising a resin mold portion that covers all of the plurality of detection element portions.

11. The wheel speed sensor according to claim 3, comprising a resin mold portion that covers all of the plurality of detection element portions.

12. The wheel speed sensor according to claim 4, comprising a resin mold portion that covers all of the plurality of detection element portions.

13. The wheel speed sensor according to claim 2, wherein the fixed member includes an insertion hole portion through which a connecting member for connecting the fixed member to a vehicle is insertable, and, of the plurality of detection element portions, a first detection element portion is disposed on one of opposite sides across the insertion hole portion in a circumferential direction of the detection target object, and a second detection element portion is disposed on the other of the opposite sides across the insertion hole portion.

14. The wheel speed sensor according to claim 3, wherein the fixed member includes an insertion hole portion through which a connecting member for connecting the fixed member to a vehicle is insertable, and, of the plurality of detection element portions, a first detection element portion is disposed on one of opposite sides across the insertion hole portion in a circumferential direction of the detection target object, and a second detection element portion is disposed on the other of the opposite sides across the insertion hole portion.
